(19) United States
(12) Patent Application Publication
(10) Pub. No.: US 2014/0321466 A1
(43) Pub. Date: Oct. 30, 2014

(54) PACKET PROCESSING METHOD FOR GETTING PACKET INFORMATION FROM LINK LIST AND RELATED PACKET PROCESSING APPARATUS THEREOF

(71) Applicant: MEDIATEK INC., Hsin-Chu (TW)

(72) Inventor: Chang-Po Ma, Hsinchu City (TW)

(73) Assignee: MEDIATEK INC., Hsin-Chu (TW)

(21) Appl. No.: 14/197,176

(22) Filed: Mar. 4, 2014

Related U.S. Application Data
(60) Provisional application No. 61/815,908, filed on Apr. 25, 2013.

(51) Int. Cl. H04L 12/741

(52) U.S. Cl. CPC H04L 45/745
USPC 370/392

(57) ABSTRACT

A packet processing method includes at least the following steps: deriving a start address from a packet index of a packet to be processed; deriving link-list access control information corresponding to the packet to be processed; and reading packet information for the packet to be processed from a link list stored in a packet information table according to the start address and the link-list access control information, wherein the link list comprises a plurality of entries each indexed by a current address and storing a next address and one packet information.

### CROSS REFERENCE TO RELATED APPLICATIONS

This application claims the benefit of U.S. provisional application No. 61/815,908, filed on Apr. 25, 2013 and incorporated herein by reference.

### BACKGROUND

The disclosed embodiments of the present invention relate to processing packets, and more particularly, to a packet processing method for getting packet information from a link list and a related packet processing apparatus thereof.

A network switch is a computer networking device that links different network devices. For example, the network switch receives an incoming packet generated from a first network device connected to it, and transmits a modified packet derived from the received packet only to a second network device for which the received packet is meant to be received. For another example, the network switch receives an incoming packet generated from a first network device connected to it, generates replicated packets based on the received packet, and transmits the replicated packets only to a plurality of second network devices for which the received packet is meant to be received.

Generally speaking, the operation of modifying or duplicating packets may require many instructions involved therein. Thus, how to efficiently deal with (e.g., replicate or modify) the received packets without using many hardware resources has become an issue to be solved in the pertinent field.

### SUMMARY

In accordance with exemplary embodiments of the present invention, a packet processing method for getting packet information from a link list and a related packet processing apparatus thereof are proposed to solve the above-mentioned problem.

According to a first aspect of the present invention, an exemplary packet processing method is disclosed. The exemplary packet processing method includes at least the following steps: deriving a start address from a packet index of a packet to be processed; deriving link-list access control information corresponding to the packet to be processed; and reading packet information for the packet to be processed from a link list stored in a packet information table according to the start address and the link-list access control information, wherein the link list comprises a plurality of entries each indexed by a current address and storing a next address and one packet information.

According to a second aspect of the present invention, an exemplary packet processing apparatus includes a packet index processing circuit, a storage device, and a table access circuit. The packet index processing circuit is arranged to derive a start address and link-list access control information from a packet index of a packet to be processed. The storage device is arranged to store a packet information table having a link list stored therein, wherein the link list comprises a plurality of entries each indexed by a current address and storing a next address and one packet information. The table access circuit is arranged to receive the start address and the link-list access control information generated from the packet index processing circuit, and read packet information for the packet to be processed from the link list stored in the packet information table according to the start address and the link-list access control information.

According to a third aspect of the present invention, an exemplary packet processing apparatus is disclosed. The exemplary packet processing apparatus includes a packet index processing circuit, a storage device, and a table access circuit. The packet index processing circuit is arranged to derive a start address from a packet index of a packet to be processed. The storage device is arranged to store a packet information table having a link list stored therein, wherein the link list comprises a plurality of entries each indexed by a current address and storing a next address and one packet information. The table access circuit is arranged to read a first entry indexed by a current address identical to the start address, wherein the table access circuit derives link-list access control information when the first entry is read, and the table access circuit reads packet information for the packet to be processed from the link list stored in the packet information table according to the start address and the link-list access control information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a packet processing apparatus according to a first embodiment of the present invention.

FIG. 2 is a block diagram illustrating a packet processing apparatus according to a second embodiment of the present invention.

FIG. 3 is a diagram illustrating a first exemplary design of getting the end information when the first entry is read based on the start address.

FIG. 4 is a diagram illustrating a second exemplary design of getting the end information when the first entry is read based on the start address.

FIG. 5 is a diagram illustrating a third exemplary design of getting the end information when the first entry is read based on the start address.

FIG. 6 is a diagram illustrating a fourth exemplary design of getting the end information when the first entry is read based on the start address.

FIG. 7 is a diagram illustrating a first exemplary design of identifying a last entry of a path for the packet to be processed.

FIG. 8 is a diagram illustrating a second exemplary design of identifying a last entry of a path for the packet to be processed.

FIG. 9 is a diagram illustrating a third exemplary design of identifying a last entry of a path for the packet to be processed.

FIG. 10 is a diagram illustrating a fourth exemplary design of identifying a last entry of a path for the packet to be processed.

FIG. 11 is a diagram illustrating a fifth exemplary design of identifying a last entry of a path for the packet to be processed.

FIG. 12 is a diagram illustrating a sixth exemplary design of identifying a last entry of a path for the packet to be processed.

FIG. 13 is a diagram illustrating a seventh exemplary design of identifying a last entry of a path for the packet to be processed.

FIG. 14 is a block diagram illustrating a packet processing apparatus according to a third embodiment of the present invention.

FIG. 15 is a block diagram illustrating a packet processing apparatus according to a fourth embodiment of the present invention.

FIG. 16 is a diagram illustrating an entry access operation performed by the table access circuit shown in FIG. 14/FIG. 15 based on the bypass information.

FIG. 17 is a diagram illustrating a first entry access operation performed by the table access circuit shown in FIG. 14/FIG. 15 based on the branch information.

FIG. 18 is a diagram illustrating a second entry access operation performed by the table access circuit shown in FIG. 14/FIG. 15 based on the branch information.

FIG. 19 is a diagram illustrating a linear link list which is re-used for providing packet processing information for different packets to be processed.

FIG. 20 is a diagram illustrating a circular link list which is re-used for providing packet processing information for different packets to be processed.

FIG. 21 is a block diagram illustrating a packet processing apparatus according to a fifth embodiment of the present invention.

FIG. 22 is a block diagram illustrating a packet processing apparatus according to a sixth embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

The main concept of the present invention is to use a smaller table to deal with (e.g., modify or replicate) the received packets, thus relaxing the hardware resource requirement. For example, a link list table (i.e., a table employing a link list data structure) may be re-used for accomplishing the tasks of processing different packets. Further description of technical features of the present invention is detailed as below.

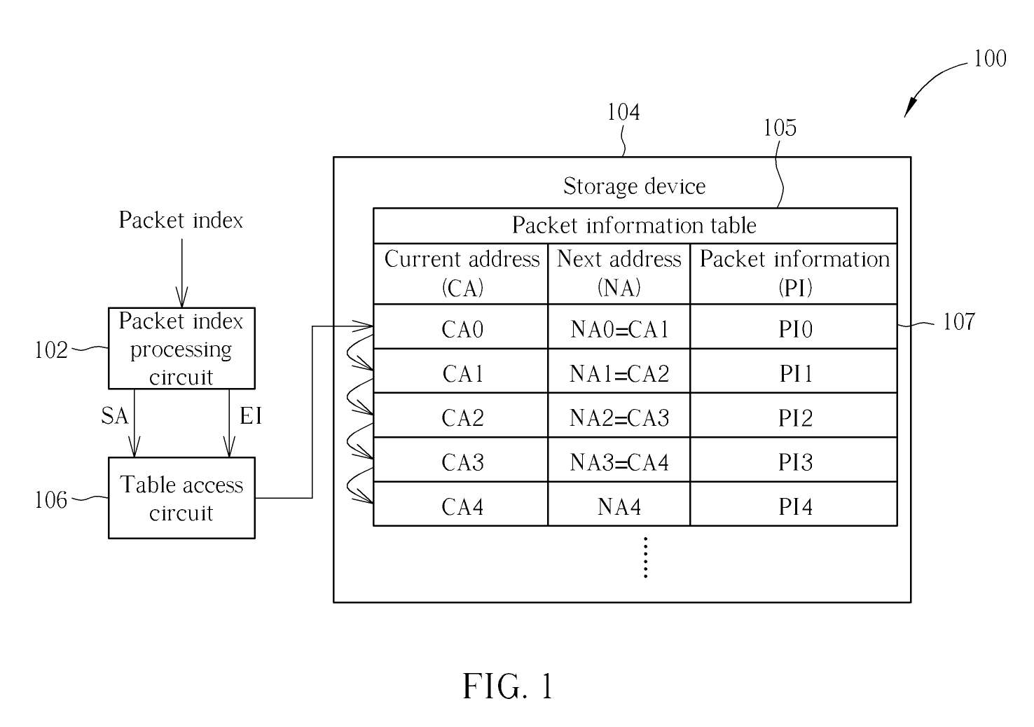

Please refer to FIG. 1, which is a block diagram illustrating a packet processing apparatus according to a first embodiment of the present invention. By way of example, but not limitation, the exemplary packet processing apparatus 100 may be implemented in a network switch. As shown in FIG. 1, the exemplary packet processing apparatus 100 includes a packet index processing circuit 102, a storage device 104 and a table access circuit 106. The packet index processing circuit 102 is arranged to derive a start address SA and end information EI from a packet index of a packet to be processed. In accordance with the packet contents and the network switch's setting made by the user/developer, the packet index can be generated or found. In one exemplary design, the start address SA and/or the end information EI may be directly calculated based on the packet index. In another exemplary design, the start address SA and/or the end information EI may be found from a pre-defined look-up table based on the packet index. The storage device 104 is arranged to store a packet information table 105 having a link list stored therein. In other words, entries 107 of the packet information table 105 form a link list. Thus, the packet information table 105 is a link list table using a link list data structure.

As shown in FIG. 1, the link list stored in the packet information table 105 is composed of entries 107 each indexed by a current address (CA) and storing at least a next address (NA) and one packet information (PI). It should be noted that the current address (CA) serves as a table entry index, and is not part of the stored table content to be read from the packet information table 105. Besides, the packet information (PI) may include N instructions or N groups of instructions, depending upon actual design consideration. The table access circuit 106 is coupled to the packet index processing circuit 102 and the storage device 104, and arranged to receive the start address SA and the end information EI generated from the packet index processing circuit 102, and read packet information for the packet to be processed from the link list stored in the packet information table 105 according to at least the start address SA and the end information EI. More specifically, the start address SA decides a first entry of a path in the link list, and the end information EI is involved in identifying a last entry of the path in the link list. Hence, the table access circuit 106 would refer to at least the end information EI to check if an end condition of the current table access for the packet to be processed is satisfied. In this way, all packet information for the packet to be processed can be retrieved from entries found in the path determined by at least the start address SA and the end information EI. Considering a case where SA=CA0 for a first packet to be processed, the packet information PI0-PI4 may be successively retrieved from the packet information table 105 due to the corresponding end information EI and the link list data structure. Considering another case where SA=CA2 for a second packet to be processed, the packet information PI3-PI4 may be successively retrieved from the packet information table 105 due to the corresponding end information EI and the link list data structure.

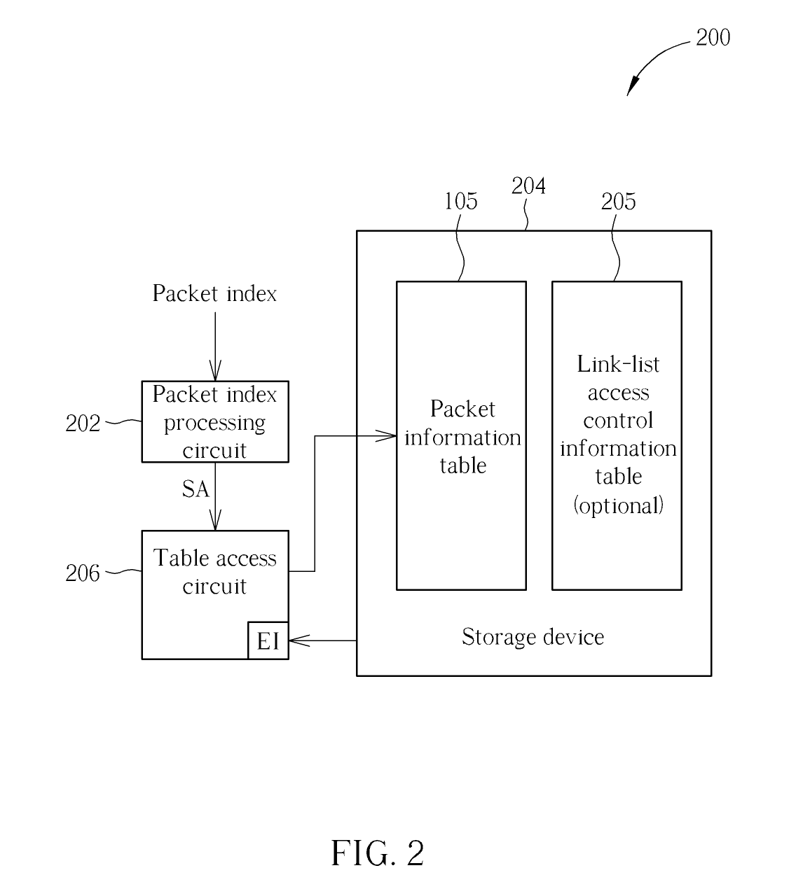

In above embodiment, the end information EI is obtained before a first entry indexed by a current address identical to the start address SA is accessed. However, this is for illustrative purposes only, and is not meant to be a limitation of the present invention. Please refer to FIG. 2, which is a block diagram illustrating a packet processing apparatus according to a second embodiment of the present invention. By way of example, but not limitation, the exemplary packet processing apparatus 200 may be implemented in a network switch. As shown in FIG. 2, the exemplary packet processing apparatus 200 includes a packet index processing circuit 202, a storage device 204 and a table access circuit 206. The packet index processing circuit 202 is arranged to derive a start address SA from a packet index of a packet to be processed. Compared to the packet index processing circuit 102 shown in FIG. 1, the packet index processing circuit 202 is not responsible for generating the end information EI. Similarly, the storage device 204 is arranged to store the aforementioned packet information table 105 having a link list stored therein. In one exemplary design, the storage device 204 may further store a link-list access control information table 205 distinct from the packet information table 105, where the link-list access control information table 205 has an end information table included therein (i.e., the link-list access control information table 205 in this case stores a plurality of candidate end information), and the end information table may be accessed to provide the required end information EI. In practice, the link-list access control information table 205, having the end information table included therein, may be optional. For example, in another exemplary design, the end information table may be omitted, and the required end information EI is derived from data provided by the packet information table 105. In this embodiment, the table access circuit 206 is coupled to the packet index processing circuit 202 and the storage device 204, and arranged to read a first entry indexed by a current address identical to the start address SA.

The table access circuit 206 obtains the end information EI when the first entry of a path in the link list is read, and reads packet information for the packet to be processed from the link list stored in the packet information table 105 according to at least the start address SA and the end information EI. The table access circuit 206 may employ one of a plurality of feasible manners to obtain the end information EI. In the following, several examples are provided for illustrative purposes.

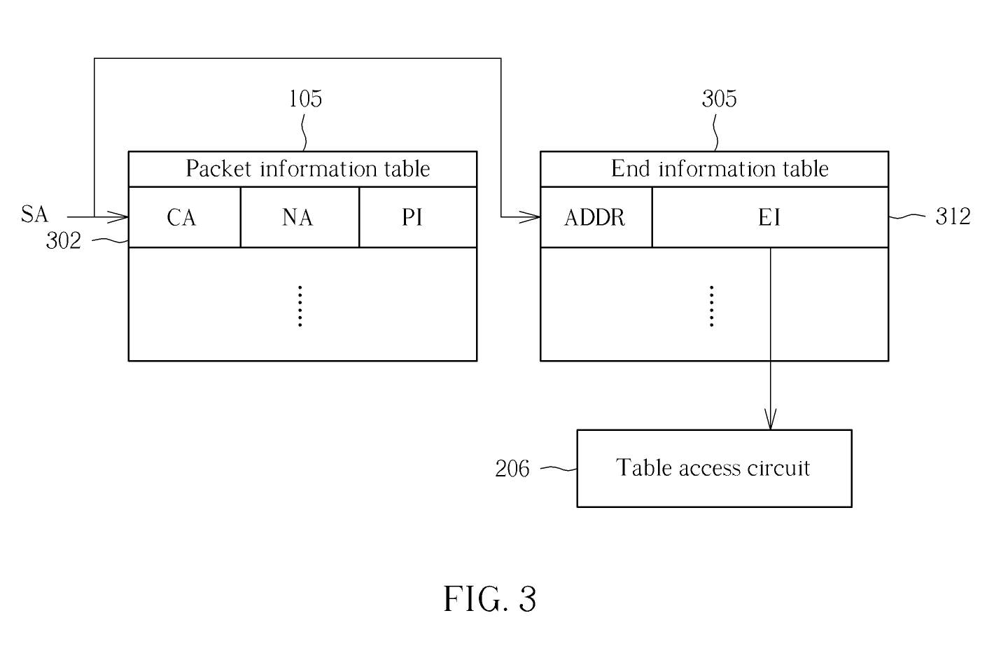

FIG. 3 is a diagram illustrating a first exemplary design of getting the end information EI when the first entry is read based on the start address SA. In this exemplary embodiment, the end information table 305 is stored in the storage device 204. As shown in FIG. 3, an entry 302 of the packet information table 105 has a table entry index (e.g., the current address CA) identical to the start address SA. Hence, the entry 302 is a first entry of a path to be accessed in the link list stored in the packet information table 105. With regard to the end information table 305, it has an entry 312 associated with the entry 302, and is indexed by an address ADDR identical to the start address SA (i.e., ADDR=SA). The end information EI stored in the entry 312 is directly retrieved from the end information table 305, and then transmitted to the table access circuit 206.

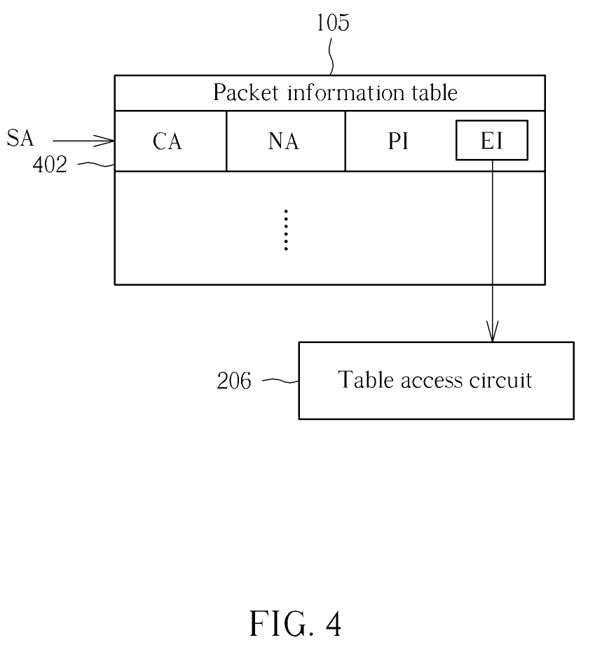

FIG. 4 is a diagram illustrating a second exemplary design of getting the end information EI when the first entry is read based on the start address SA. In this exemplary embodiment, the aforementioned end information table 305 may be omitted. Instead, the end information EI is embedded in the packet information PI stored in one entry of the packet information table 105. As shown in FIG. 4, an entry 402 of the packet information table 105 has a table entry index (e.g., the current address CA) identical to the start address SA. Hence, the entry 402 is a first entry of a path to be accessed in the link list stored in the packet information table 105. The end information EI is a portion of the packet information PI of the entry 402. For example, the end information EI may be a parameter stored in a field of the packet information PI of the entry 402. Hence, the end information EI is directly extracted from the packet information PI stored in the entry 402, and then transmitted to the table access circuit 206.

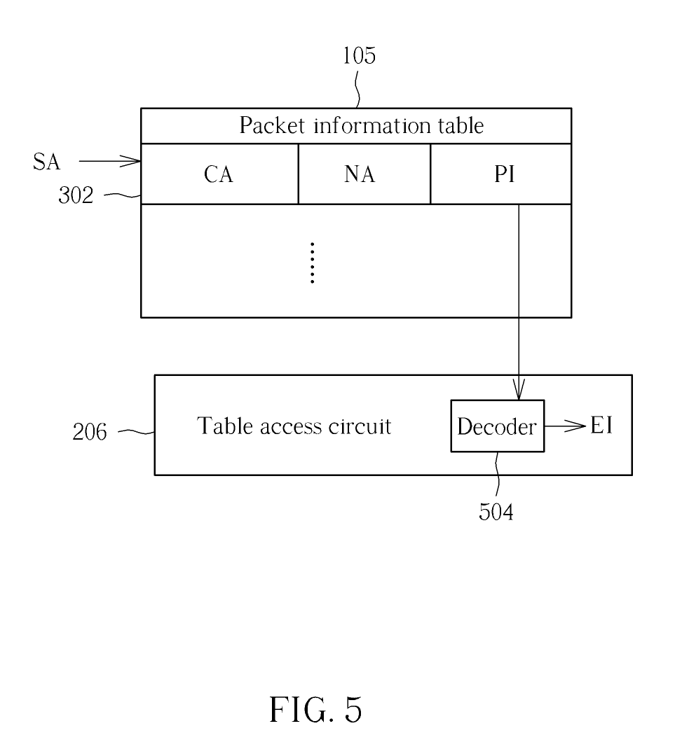

FIG. 5 is a diagram illustrating a third exemplary design of getting the end information EI when the first entry is read based on the start address SA. In this exemplary embodiment, the aforementioned end information table 305 may be omitted. The table access circuit 206 has a decoder 504 implemented therein. As shown in FIG. 5, the entry 302 of the packet information table 105 has a table entry index (e.g., the current address CA) identical to the start address SA. Hence, the entry 302 is a first entry of a path to be accessed in the link list stored in the packet information table 105. When the entry 302 is accessed, the packet information PI is retrieved and transmitted to the decoder 504 of the table access circuit 206. Next, the decoder 504 decodes the packet information PI to generate the end information EI.

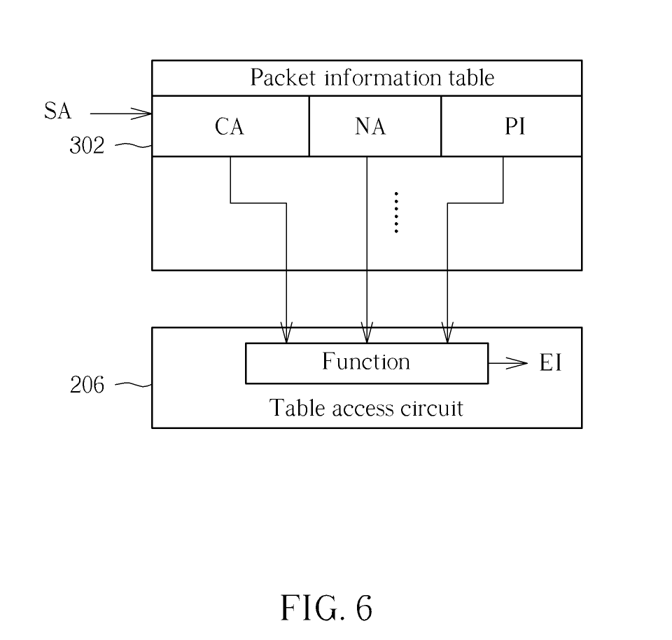

FIG. 6 is a diagram illustrating a fourth exemplary design of getting the end information EI when the first entry is read based on the start address SA. In this exemplary embodiment, the aforementioned end information table 305 may be omitted. As shown in FIG. 6, the entry 302 of the packet information table 105 has a table entry index (e.g., the current address CA) identical to the start address SA. Hence, the entry 302 is a first entry of a path to be accessed in the link list stored in the packet information table 105. At least one of the current address CA, the next address NA and the packet information PI associated with the entry 302 may be used by the table access circuit 206 to calculate the end information EI. In this embodiment, the table access circuit 206 calculates the end information EI based on an output of a predetermined function F using the current address CA, the next address NA and/or the packet information PI of the first entry 302 as its input. That is, EI=F(CA), F(NA), F(PI), F(CA, NA), F(CA, PI), F(NA, PI), or F(CA, NA, PI), depending upon actual design consideration.

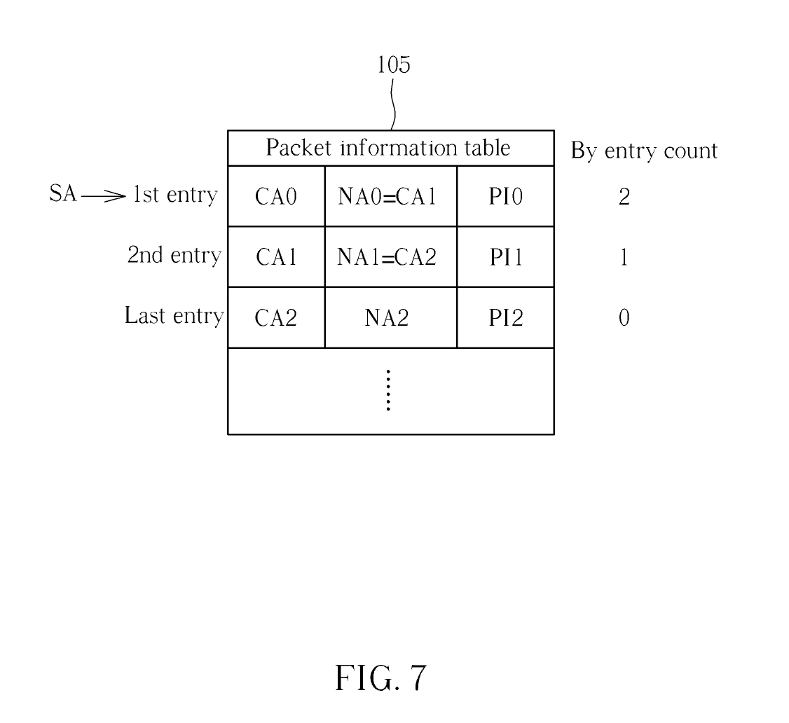

As mentioned above, the start address SA is used to determine which table entry of the packet information table 105 is a first entry of a path in the link list for the packet to be processed, and the end information EI is involved in identifying a last entry of the path in the link list. In one exemplary design, the end information EI may be set by a target entry count. Please refer to FIG. 7, which is a diagram illustrating a first exemplary design of identifying a last entry of a path for the packet to be processed. In this example, SA=CA0 and EI=2. Hence, a path in the link list that corresponds to the packet to be processed begins at an entry indexed by the current address CA0 identical to the start address SA. The table access circuit 106/206 would monitor the number of accessed entries of the path in the link list, and identifies a last entry of the path when the number of accessed entries matches the target entry count (e.g., 2). In this embodiment, the table access circuit 106/206 initially sets a count value by the target entry count, and decreases the count value by one each time an entry has been accessed. Hence, when the count value is reduced to zero, the last entry is found. As shown in FIG. 7, after the first entry is accessed to obtain the next address NA0 and the packet information PI0, the count value is reduced to one. As the count value is not equal to zero yet, the table access circuit 106/206 determines that the current entry is not the last entry, such that the next entry (i.e., the second entry indexed by the current address CA1) is accessed based on the next address NA0 stored in the first entry. After the second entry is accessed to obtain the next address NA1 and the packet information PI1, the count value is reduced to zero. As the count value is now equal to zero, the table access circuit 106/206 determines that the next entry is the last entry. Hence, the last entry indexed by the current address CA2 is accessed based on the next address NA1 stored in the second entry. After the packet information PI2 is read from the last entry, all of the packet information PI0-PI2 for the packet to be processed is obtained from the packet information table 105.

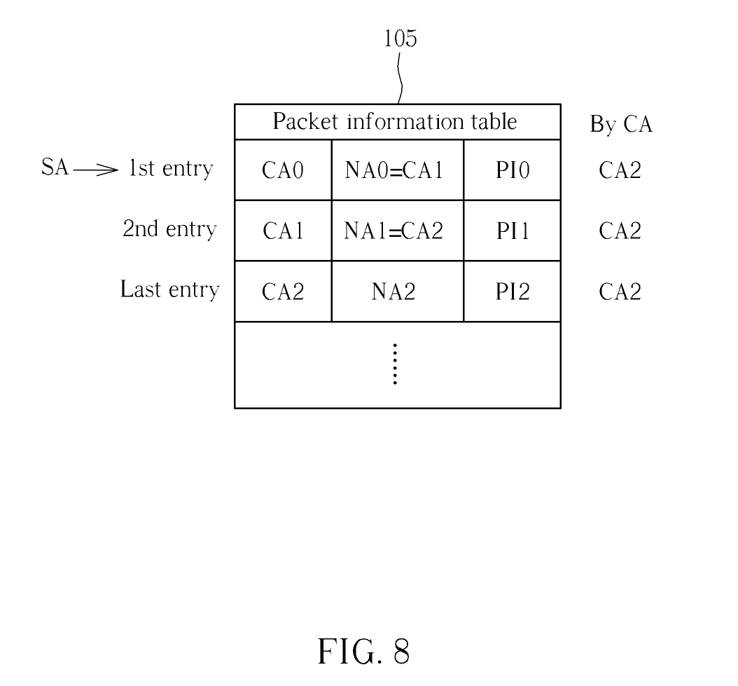

In another exemplary design, the end information EI may be set by a target current address. Please refer to FIG. 8, which is a diagram illustrating a second exemplary design of identifying a last entry of a path for the packet to be processed. In this example, SA=CA0 and EI=CA2. Hence, a path in the link list that corresponds to the packet to be processed begins at an entry indexed by the current address CA0 identical to the start address SA. The table access circuit 106/206 would compare a current address of an accessed entry of the path with the target current address (e.g., CA2), and identifies a last entry of the path when a current address of a specific accessed entry matches the target current address (e.g., CA2).

As shown in FIG. 8, when the first entry is accessed based on the start address SA, the current address CA0 is different from the target current address CA2. Thus, the table access circuit 106/206 determines that the current entry is not the last entry, such that the next entry (i.e., the second entry indexed by the current address CA1) is accessed based on the next address NA0 stored in the first entry. Since the current address CA1 of the second entry is still different from the target current address, the table access circuit 106/206 determines that the current entry is not the last entry, such that the next entry indexed by the current address CA2 is accessed based on the next address NA1 stored in the second entry. As the current address CA2 of the next entry is identical to the target current address, the table access circuit 106/206 determines that the next entry is the last entry. Hence, after the packet information PI2 is read from the last entry, all of the packet information PI0-PI2 for the packet to be processed is obtained from the packet information table 105.

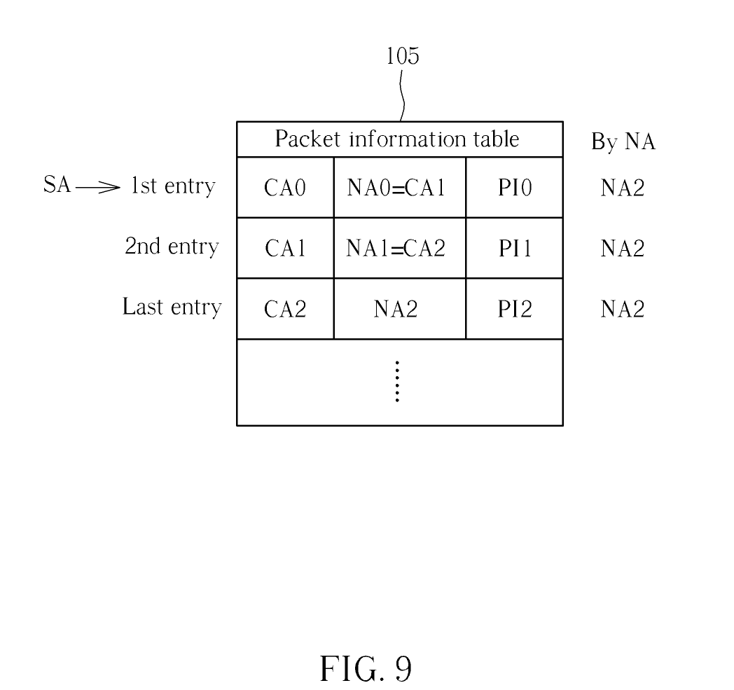

In another exemplary design, the end information EI may be set by a target next address. Please refer to FIG. 9, which is a diagram illustrating a third exemplary design of identifying a last entry of a path for the packet to be processed. In this example, SA=CA0 and EI=NA2. Hence, a path in the link list that corresponds to the packet to be processed begins at an entry indexed by the current address CA0 identical to the start address SA. The table access circuit 106/206 would compare a next address stored in an accessed entry of the path with the target next address (e.g., NA2), and identifies a last entry of the path when a next address stored in a specific accessed entry matches the target next address (e.g., NA2).

As shown in FIG. 9, when the first entry is accessed based on the start address SA, the table access circuit 106/206 finds that the next address NA0 is different from the target next address NA2. Thus, the second entry indexed by the current address CA1 is accessed based on the next address NA0 stored in the first entry. When the second entry is accessed, the table access circuit 106/206 finds that the next address NA1 is still different from the target next address NA2. Thus, the next entry indexed by the current address CA2 is accessed based on the next address NA1 stored in the second entry. When the entry indexed by the current address CA2 is accessed, the table access circuit 106/206 identifies the entry indexed by the current address CA2 as the last entry of the path due to the fact that the next address NA2 is identical to the target next address NA2. Hence, after the packet information PI2 is read from the last entry, all of the packet information PI0-PI2 for the packet to be processed is obtained from the packet information table 105.

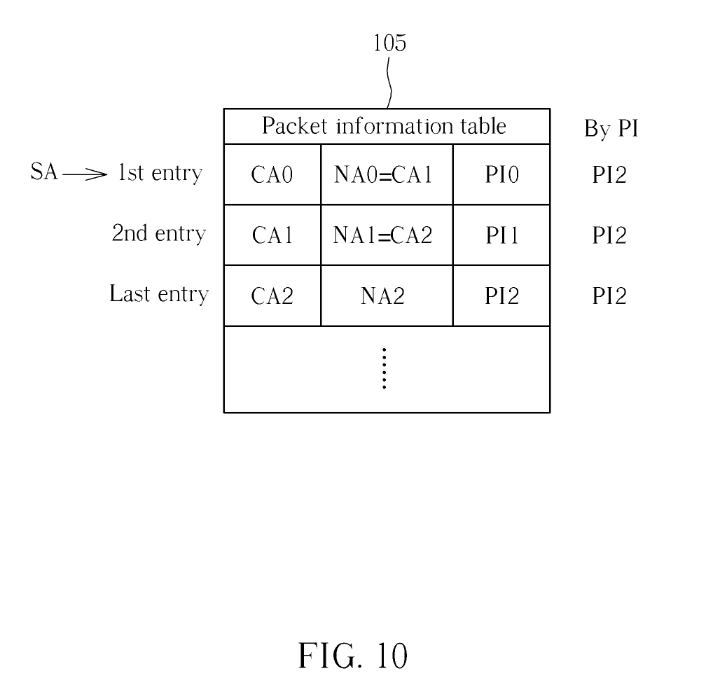

In another exemplary design, the end information EI may be set by target packet information. Please refer to FIG. 10, which is a diagram illustrating a fourth exemplary design of identifying a last entry of a path for the packet to be processed. In this example, SA=CA0 and EI=PI2. Hence, a path in the link list that corresponds to the packet to be processed begins at an entry indexed by the current address CA0 identical to the start address SA. The table access circuit 106/206 would compare packet information stored in an accessed entry of the path with the target packet information (e.g., PI2), and identifies a last entry of the path when packet information stored in a specific accessed entry matches the target packet information (e.g., PI2).

As shown in FIG. 10, when the first entry is accessed based on the start address SA, the table access circuit 106/206 finds that the packet information PI0 is different from the target packet information PI2. Thus, the second entry indexed by the current address CA1 is accessed based on the next address NA0 stored in the first entry. When the second entry is accessed, the table access circuit 106/206 finds that the packet information PI1 is still different from the target packet information PI2. Thus, the next entry indexed by the current address CA2 is accessed based on the next address NA1 stored in the second entry. When the entry indexed by the current address CA2 is accessed, the table access circuit 106/206 identifies the entry indexed by the current address CA2 as the last entry of the path due to the fact that the packet information PI2 is identical to the target packet information PI2. Hence, after the packet information PI2 is read from the last entry, all of the packet information PI0-PI2 for the packet to be processed is obtained from the packet information table 105.

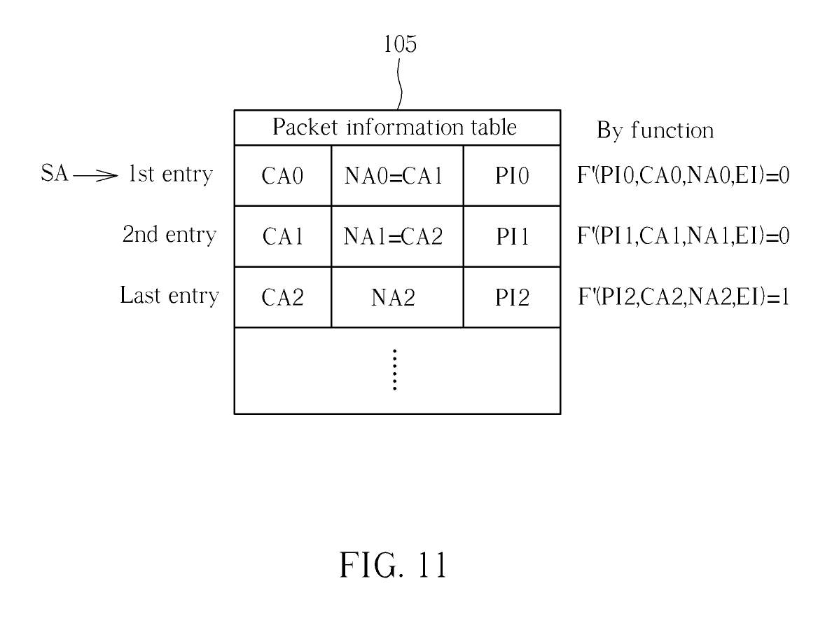

In another exemplary design, the last entry may be found by the table access circuit 106/206 through a predetermined function. Please refer to FIG. 11, which is a diagram illustrating a fifth exemplary design of identifying a last entry of a path for the packet to be processed. In this example, SA=CA0. Hence, a path in the link list that corresponds to the packet to be processed begins at an entry indexed by the current address CA0 identical to the start address SA. When one entry of the path is accessed, the table access circuit 106/206 checks if an output of a predetermined function F′ with an input including at least one of the end information EI, the packet information stored in the accessed entry, the current address of the accessed entry, and the next address stored in the accessed entry matches a target value (e.g., 1). In this embodiment, the predetermined function F′ may use multiple parameters as its input, where the parameters include the end information EI, the packet information stored in the accessed entry, the current address of the accessed entry, and the next address stored in the accessed entry. However, this is for illustrative purposes only, and is not meant to be a limitation of the present invention. In an alternative design, the function F′ may be modified to use a portion of the aforementioned parameters and/or other parameter (s) as its input.

As shown in FIG. 11, when the first entry is accessed based on the start address SA, the table access circuit 106/206 finds that the output of the function F′ (PI0, CA0, NA0, EI) is different from the target value (e.g., 1). Thus, the second entry indexed by the current address CA1 is accessed based on the next address NA0 stored in the first entry. When the second entry is accessed, the table access circuit 106/206 finds that the output of the function F′ (PI1, CA1, NA1, EI) is still different from the target value (e.g., 1). Thus, the next entry indexed by the current address CA2 is accessed based on the next address NA1 stored in the second entry. When the entry indexed by the current address CA2 is accessed, the table access circuit 106/206 identifies the entry indexed by the current address CA2 as the last entry of the path due to the fact that the output of the function F′ (PI2, CA2, NA2, EI) is identical to the target value (e.g., 1). Hence, after the packet information PI2 is read from the last entry, all of the packet information PI0-PI2 for the packet to be processed is obtained from the packet information table 105.

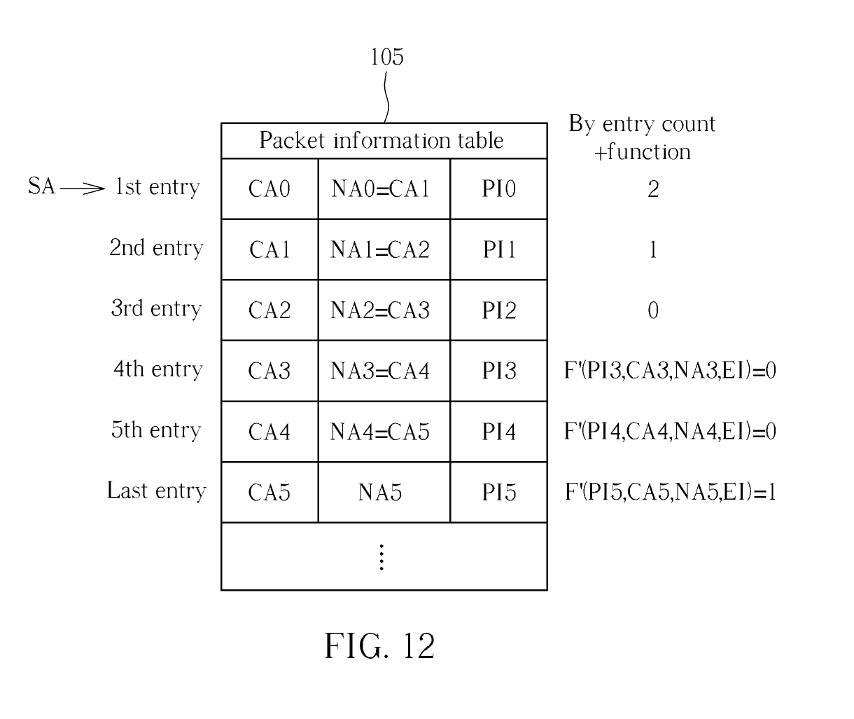

In above exemplary designs, the last entry is determined by checking a single criterion. Alternatively, the last entry may be determined by checking a combination of multiple criteria. FIG. 12 is a diagram illustrating a sixth exemplary design of identifying a last entry of a path for the packet to be processed. In this example, a first criterion is defined based on the number of accessed entries, and a second criterion is defined based on the output of the predetermined function F′, where the second criterion is not checked until the first criterion is satisfied. Hence, the first criterion and the second criterion are sequentially checked to find the last entry. More specifically, the last entry of the path corresponding to the packet to be processed is identified when an output of the predetermined function F′ matches a target value (e.g., 1) after the number of accessed entries of the path in the link list matches a target entry count (e.g., 2). However, this is for illustrative purposes only, and is not meant to be a limitation of the present invention. In an alternative design, the function F′ may be modified to use a portion of the aforementioned parameters and/or other parameter(s) as its input. For example, F′(PI, CA, NA, EI, T) may be used, where T may be a target entry count or a certain time point. As a person skilled in the art can readily understand details of the operation of checking multiple criteria after reading above paragraphs directed to the examples shown in FIG. 7 and FIG. 11, further description is omitted here for brevity.

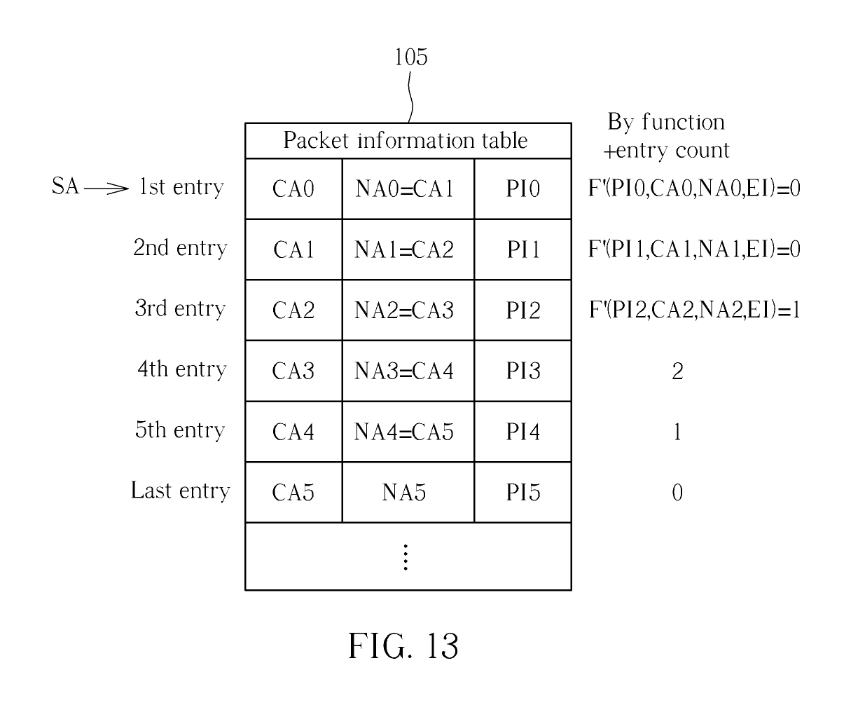

FIG. 13 is a diagram illustrating a seventh exemplary design of identifying a last entry of a path for the packet to be processed. In this example, a first criterion is defined based on the output of the predetermined function F′, and a second criterion is defined based on the number of accessed entries, where the second criterion is not checked until the first criterion is satisfied. Hence, the last entry of the path corresponding to the packet to be processed is identified when the number of accessed entries in the link list matches a target entry count (e.g., 2) after an output of the predetermined function F′ matches a target value (e.g., 1). As a person skilled in the art can readily understand details of the operation of checking multiple criteria after reading above paragraphs directed to the examples shown in FIG. 7 and FIG. 11, further description is omitted here for brevity.

As shown in FIG. 1, entries 107 of the packet information table 105 are linked one by one based on successive next addresses stored therein. Hence, when the first entry is determined by the start address SA, entries in the packet information table 105 are successively accessed according to the next addresses until the last entry is determined based on at least the end information EI. For example, the packet information PI0-PI4 is sequentially retrieved based on the link list data structure employed by the packet information table. To improve the flexibility of re-using the packet information table 105, the operation of reading packet information stored in a next entry pointed to by a next address stored in a current entry may be bypassed or branched. For example, the operation of reading the packet information PI2 is bypassed/branched. As a result, only the packet information PI0, PI1, PI3 and PI4 is sequentially retrieved based on the link list data structure employed by the packet information table 105. Further description of the proposed bypass/branch operation is detailed as below.

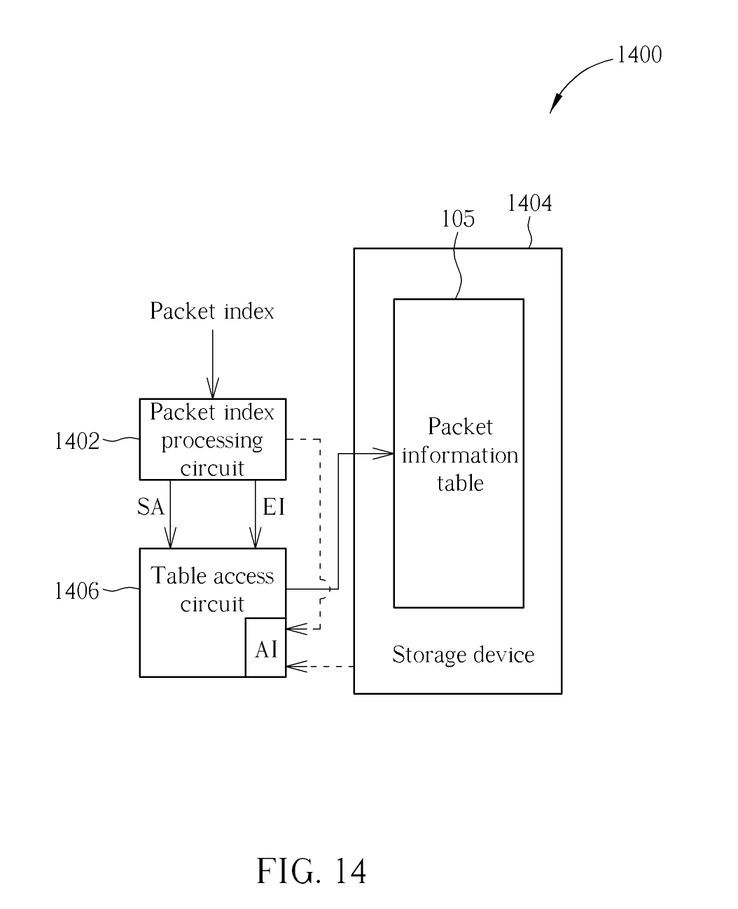

Please refer to FIG. 14, which is a block diagram illustrating a packet processing apparatus according to a third embodiment of the present invention. By way of example, but not limitation, the exemplary packet processing apparatus 1400 may be implemented in a network switch. As shown in FIG. 14, the exemplary packet processing apparatus 1400 includes a packet index processing circuit 1402, a storage device 1404 and a table access circuit 1406. The structure and operation of the packet processing apparatus 1400 are similar to that of the packet processing apparatus 100 shown in FIG. 1. The major difference is that the table access circuit 1406 further derives additional information (e.g., bypass information or branch information) AI corresponding to the packet to be processed. For example, the additional information (e.g., bypass information or branch information) AI may be obtained using one of the above-mentioned manners used for obtaining the end information EI. That is, the additional information (e.g., bypass information or branch information) AI may be calculated or found from a look-up table by the packet index processing circuit 1402, or obtained using the same concept implemented in one of the exemplary end information acquisition designs shown in FIG. 3-FIG. 6.

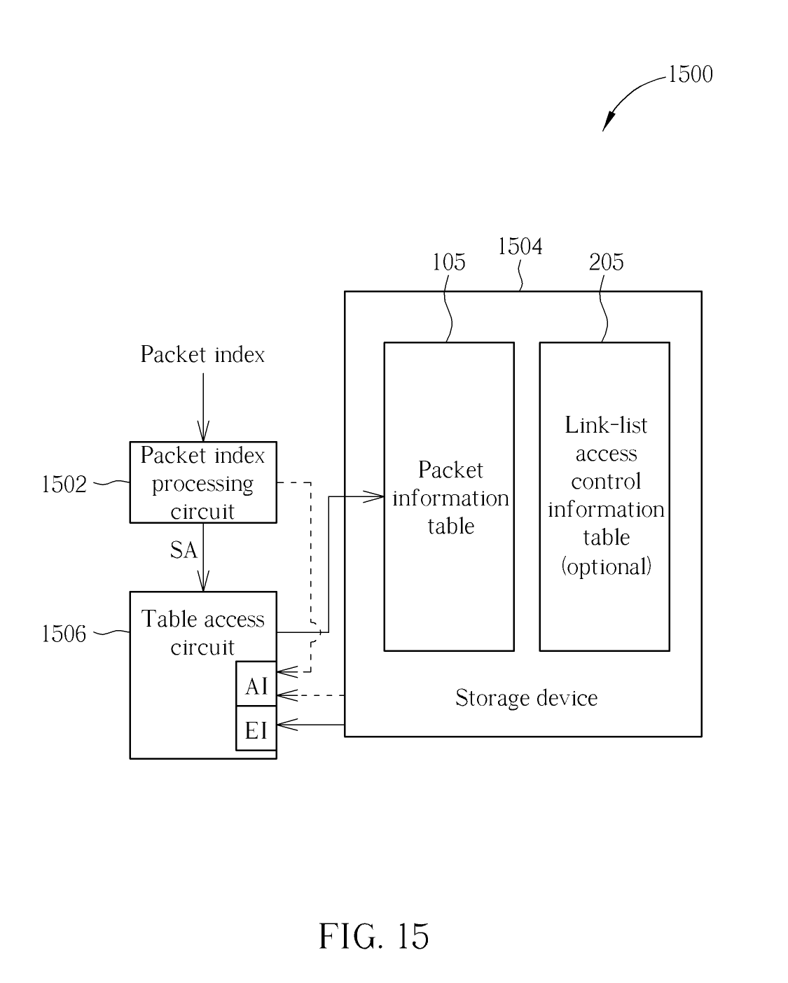

Please refer to FIG. 15, which is a block diagram illustrating a packet processing apparatus according to a fourth embodiment of the present invention. By way of example, but not limitation, the exemplary packet processing apparatus 1500 may be implemented in a network switch. As shown in FIG. 15, the exemplary packet processing apparatus 1500 includes a packet index processing circuit 1502, a storage device 1504 and a table access circuit 1506. The structure and operation of the packet processing apparatus 1500 are similar to that of the packet processing apparatus 200 shown in FIG. 2. The major difference is that the table access circuit 1506 further derives additional information (e.g., bypass information or branch information) AI corresponding to the packet to be processed. For example, the additional information (e.g., bypass information or branch information) AI is obtained using one of the above-mentioned manners used for obtaining the end information EI. That is, the additional information (e.g., bypass information or branch information) AI may be calculated or found from a look-up table by the packet index processing circuit 1502, or obtained using the same concept implemented in one of the exemplary end information acquisition designs shown in FIG. 3-FIG. 6.

Each of the link-list access control information (e.g., end information EI, bypass information AI_{BY} and branch information AI_{BR}) may be individually obtained based on one of the proposed identification manners. In a preferred embodiment, all of the aforementioned link-list access control information, including end information EI, bypass information AI_{BY} and branch information AI_{BR}, will be used for controlling the data access of table entries of the path corresponding to a packet to be processed. By way of example, concerning one accessed entry in the packet information table, a predetermined function may be used to decide whether a bypass condition or a branch condition is met. For example, when F₁(PI, CA, NA, AI_{BY})=1, the accessed entry is bypassed; and when F₂(PI, CA, NA, AI_{BR})=NA*, the access of the link list will be branched to an entry pointed to by the next address NA*. However, this is for illustrative purposes only, and is not meant to be a limitation of the present invention. For example, using one of the proposed identification manners to obtain any link-list access control information (e.g., one or more of end information, bypass information and branch information) still falls within the scope of the present invention.

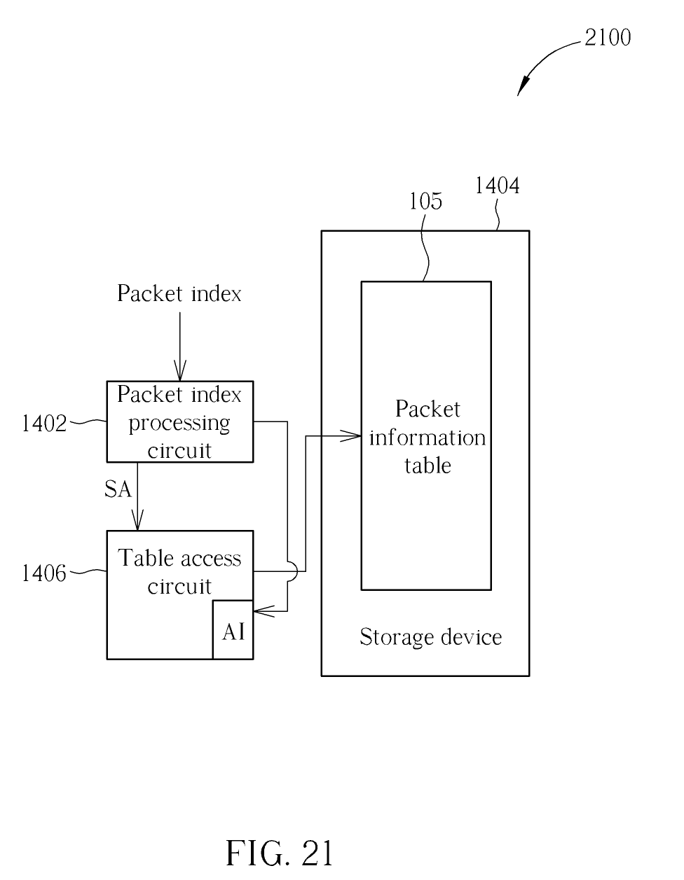

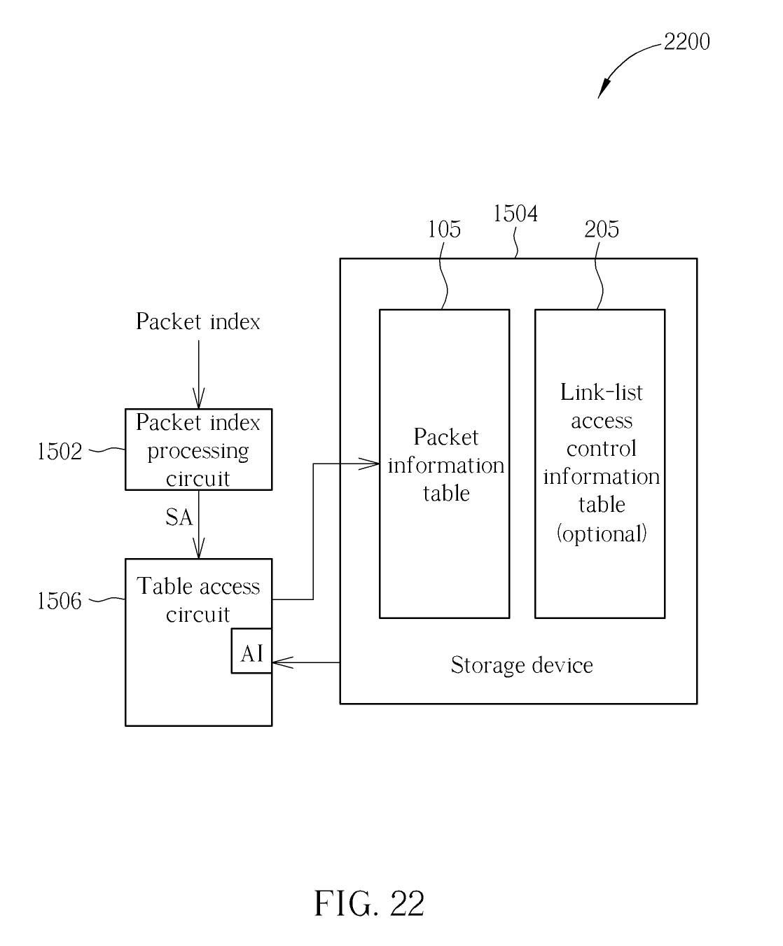

Specifically, the packet processing apparatus 1400 shown in FIG. 14 may be modified to omit elements/procedures associated with derivation of the end information EI, as illustrated by the packet processing apparatus 2100 shown in FIG. 21. Similarly, the packet processing apparatus 1500 shown in FIG. 15 may be modified to omit elements/procedures associated with derivation of the end information EI and make the optional link-list access control information table 205 have a bypass information table and/or a branch information table included therein (i.e., the link-list access control information table 205 in this case stores a plurality of candidate bypass information and/or a plurality of candidate branch information), as illustrated by the packet processing apparatus 2200 shown in FIG. 22. To put it simply, in one exemplary embodiment, the bypass information may be obtained using one of the proposed identification manners, while one or both of the end information and the branch information may be obtained by other means. In another exemplary embodiment, the branch information may be obtained using one of the proposed identification manners, while one or both of the end information and the bypass information may be obtained by other means. The same objective of obtaining link-list access control information based on the proposed identification manner is achieved.

Further details associated with the bypass/branch information are described as below.

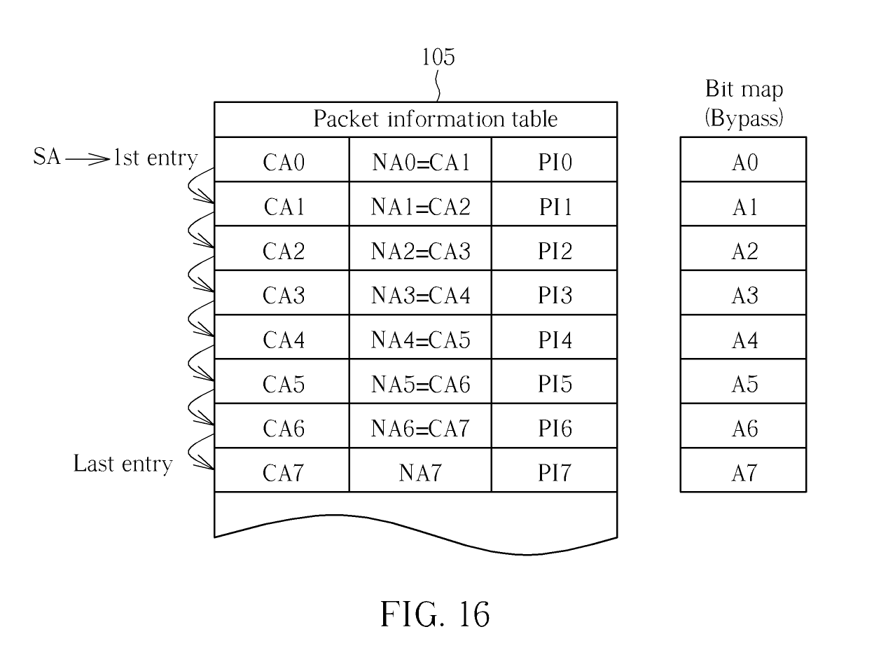

Consider a case where the additional information AI used by the table access circuit 1406/1506 is the bypass information. In an exemplary embodiment, the bypass information AI indicates whether packet information stored in an accessed entry in the link list should be retrieved. For example, the bypass information AI may be simply implemented using a bit map, where each bit of the bit map may be determined based one of the proposed identification manners mentioned above for deciding the end information. Please refer to FIG. 16, which is a diagram illustrating an entry access operation performed by the table access circuit 1406/1506 based on the bypass information AI. Suppose that a path in the link list has 8 entries, where a first entry of the path is defined by the start address SA and a last entry of the path is defined by at least the end information EI. Each of the next addresses NA0-NA6 would be accessed to find the next entry; however, each of the packet information PI0-PI7 is selectively accessed according to a corresponding bit defined in the bit map. For example, when one bit of the bit map is set by “1”, the packet information stored in an associated entry is bypassed (i.e., the packet information stored in the associated entry is not read). Hence, when the bit sequence of A0-A7 is “00000000”, all of the packet information PI0-PI7 is retrieved for the packet to be processed. For another example, when the bit sequence of A0-A7 is “00011000”, only the packet information PI0-PI2 and P15-PI7 is retrieved for the packet to be processed. For yet another example, when the bit sequence of A0-A7 is “00000001”, only the packet information PI0-PI6 is retrieved for the packet to be processed. Thus, with the help of the bypass information, the flexibility of re-using the packet information table is improved greatly.

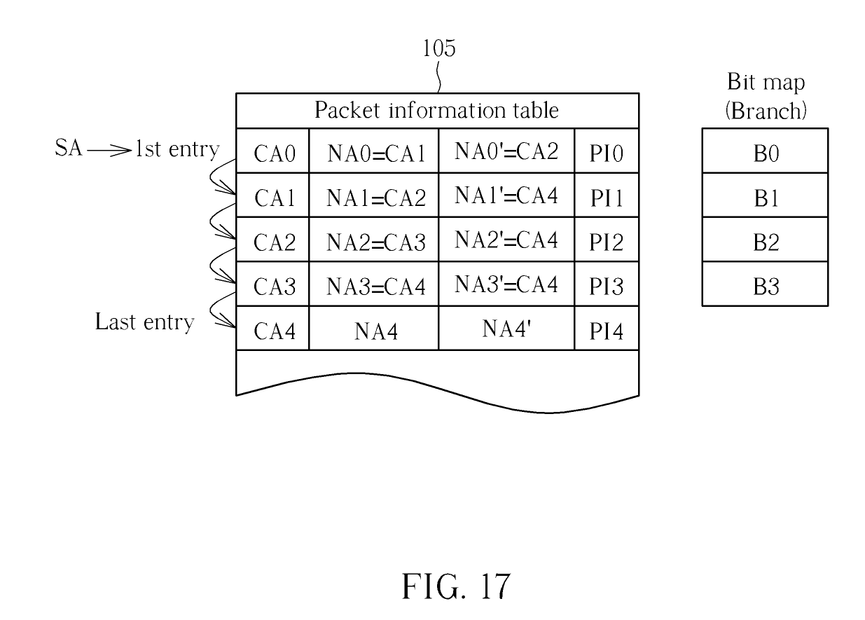

Consider another case where the additional information AI used by the table access circuit 1406/1506 is the branch information. In a first exemplary embodiment, each entry in the link list is configured to store more than one next address, and the branch information AI indicates which one of next addresses stored in an accessed entry in the link list should be used to find the next entry. For example, the branch information may be simply implemented using a bit map, where each bit of the bit map may be determined based one of the proposed identification manners mentioned above for deciding the end information. Please refer to FIG. 17, which is a diagram illustrating a first entry access operation performed by the table access circuit 1406/1506 based on the branch information AI. A first entry of a path for the packet to be processed is defined by the start address SA, and a last entry of the path is defined by at least the end information EI. However, the entries actually included in the path may be controlled based on the branch information AI. In this embodiment, each entry in the link list has two next addresses which may be identical to or different from each other. One of the two next addresses in an accessed entry is selected based on a corresponding bit defined in the bit map. For example, when a bit of the bit map is set by “0”, the first next address (e.g., NA0) stored in an associated entry is used, and when the bit of the bit map is set by “1”, the second next address (e.g., NA0′) stored in the associated entry is used. For example, when the bit sequence of B0-B3 is “0000”, all of the packet information PI0-PI4 is retrieved for the packet to be processed. For another example, when the bit sequence of B0-B3 is “0010”, only the packet information PI0-PI2 and PI4 is retrieved for the packet to be processed. For yet another example, when the bit sequence of B0-B3 is “0100”, only the packet information PI0-Phi and PI4 is retrieved for the packet to be processed. Thus, with the help of the branch information (e.g., the bit map), the flexibility of re-using the packet information table is improved greatly.

In above example shown in FIG. 17, each entry of the packet information table is required to store more than one next address, which would increase the hardware resource requirement inevitably. In an alternative design, the branch information AI may be configured to indicate an address offset for a next address stored in an accessed entry. To put it another way, the second next address (e.g., NA0′) may be regarded as the first next address (e.g., NA0) plus an address offset (e.g., NA0′-NA0). If the address offset is set by a zero value, the first next address (e.g., NA0) is used. If the address offset is set by a no-zero value, a different next address derived from shifting the first next address (e.g., NA0) by the address offset is used. Therefore, a next entry in the link list is found based on a next address stored in an accessed entry and an address offset specified in the branch information for the accessed entry. As the size of the address offset is smaller than the size of the second next address, the hardware resource requirement is relaxed correspondingly.

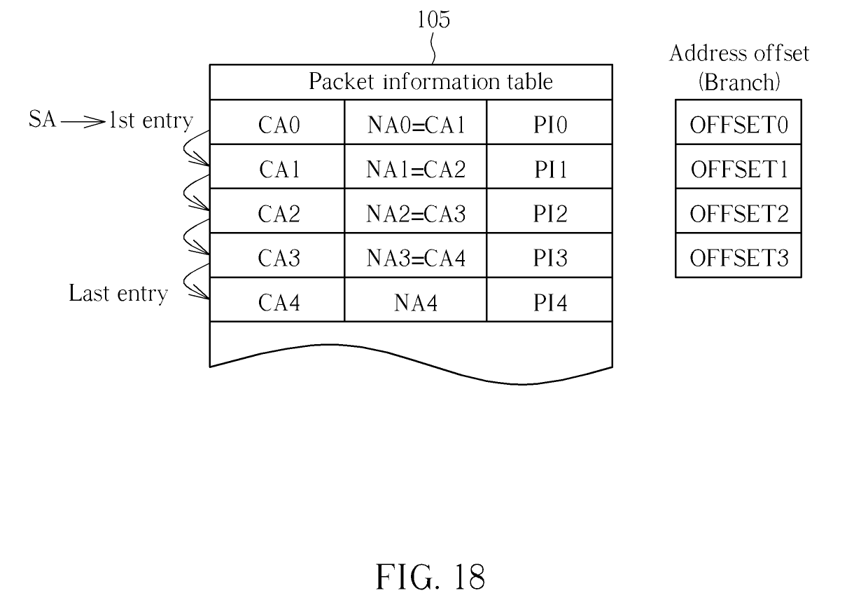

Please refer to FIG. 18, which is a diagram illustrating a second entry access operation performed by the table access circuit 1406/1506 based on the branch information AI. A first entry of a path for the packet to be processed is defined by the start address SA, and a last entry of the path is defined by at least the end information EI. However, the entries included in the path may be controlled based on the branch information AI. In this embodiment, each of the address offsets OFFSET0-OFFSET3 is used to adjust a next address stored in an associated entry, and may be set by a zero value or a non-zero value, where each address offset may be determined based one of the proposed identification manners mentioned above for deciding the end information. For example, when each of the address offsets OFFSET0-OFFSET3 is set by a zero value, all of the packet information PI0-PI4 is retrieved for the packet to be processed. For another example, when each of the address offsets OFFSET0, OFFSET1, OFFSET3 is set by a zero value and the address offset OFFSET2 is set by (CA4-CA3), only the packet information PI0-PI2 and PI4 is retrieved for the packet to be processed. For yet another example, when each of the address offsets OFFSET0, OFFSET2, OFFSET3 is set by a zero value and the address offset OFFSET1 is set by (CA4-CA2), only the packet information PI0-PI1 and PI4 is retrieved for the packet to be processed. Thus, with the help of the branch information (e.g., address offsets), the flexibility of re-using the packet information table is improved greatly.

In above embodiments, the packet information read from the link list includes packet processing information related to the packet. For example, the packet information may be replication information or packet modification information. In a case where the packet information is packet modification information, one packet modification information read from one accessed entry of the packet information table may be an instruction, a pointer of an instruction, or a group of instructions related to modification of a received packet which is generated from a first network device. Hence, based on all the packet modification information retrieved from a path in the link list, the network switch derives a modified packet from processing the received packet. Next, the network switch transmits the modified packet only to a second network device for which the received packet is meant to be received. In another case where the packet information is replication information, one packet modification information read from one accessed entry of the packet information table may be an instruction, a pointer of an instruction, or a group of instructions related to replication of a received packet which is generated from a first network device. Hence, based on all the replication information retrieved from a path in the link list, the network switch derives replicated packets from processing the received packet. Next, the network switch transmits the replicated packets only to a plurality of second network devices for which the received packet is meant to be received.

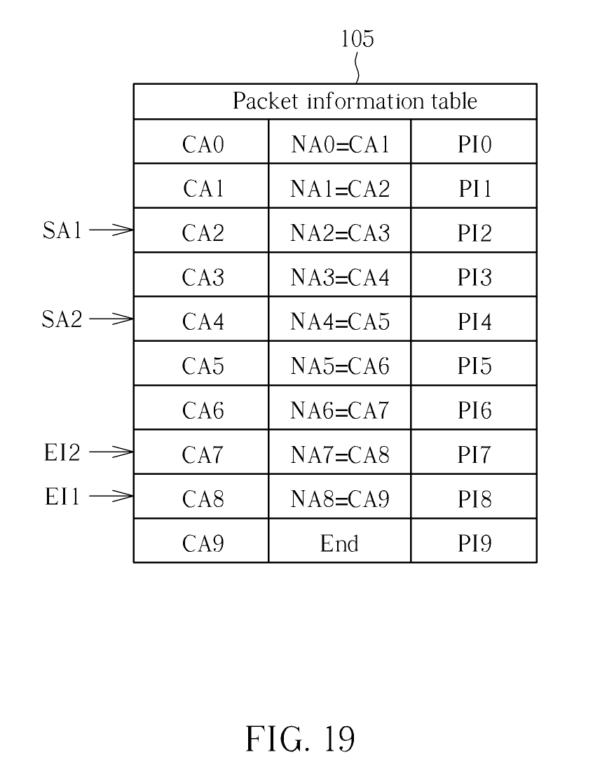

It should be noted that the packet information table 105 may include a linear link list only, a circular link list only, or a combination of at least one linear link list and at least one circular link list, depending upon actual design consideration. As a first entry of a path is determined by a start address SA generated in response to a packet index of an incoming packet to be processed, the first entry of the path is not necessarily a first entry of a link list stored in the packet information table 105. Please refer to FIG. 19, which is a diagram illustrating a linear link list which is re-used for providing packet processing information for different packets to be processed. In this example, the linear link list has a first entry indexed by the current address CA0 and a last entry indexed by the current address CA9. Regarding a first packet to be processed, first start address SA1 and first end information EI1 are derived using the aforementioned manners. Regarding a second packet to be processed, second start address SA1 and second end information EI2 are derived using the aforementioned manners. Hence, a first path in the linear link list is determined based on at least the first start address SA1 and the first end information EI1, and a second path in the linear link list is determined based on at least the second start address SA2 and the second end information EI2.

More specifically, the first path is comprised of entries indexed by current addresses CA2-CA8, and the second path is comprised of entries indexed by current addresses CA4-CA7. Since the end information EI1/EI2 is involved in identifying a last entry of the first path/second path, the last entry of the first path/second path is not necessarily the last entry of the linear link list. As shown in FIG. 19, each of the first path and the second path has a last entry different from the last entry of the linear link list. Besides, since the start address and the end information are dynamically obtained for each packet to be processed, different paths in the same linear link list may have the same first entry but different last entries, different first entries but the same last entry, or different first entries and different last entries. For example, as shown in FIG. 19, the first path and the second path have different first entries (i.e., SA1≠SA2) and different last entries (i.e., EI1≠EI2). Briefly summarized, when the proposed packet processing method is employed by a network switch, the linear link list can be re-used to meet different packet processing requirements of incoming packets of the network switch.

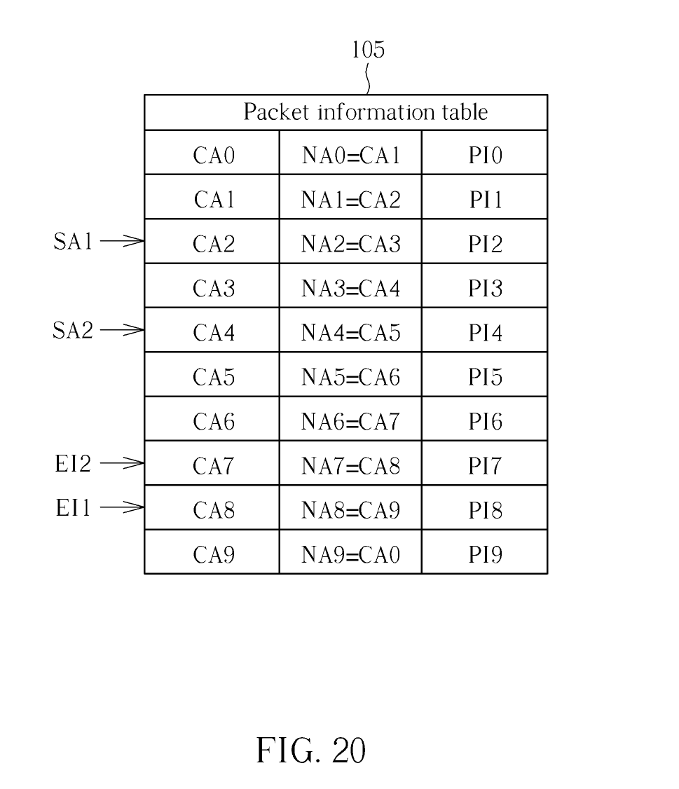

Please refer to FIG. 20, which is a diagram illustrating a circular link list which is re-used for providing packet processing information for different packets to be processed. In this example, the circular link list has a first entry indexed by the current address CA0; however, the circular link list has no last entry due to its inherent characteristics. For example, as shown in FIG. 20, when the entry indexed by the current address CA9 is accessed, the next entry to be accessed is indexed by the next address NA9 which is set by CA0. As a result, the entry indexed by CA0 will be accessed again. Regarding a first packet to be processed, first start address SA1 and first end information EI1 are derived using the aforementioned manners. Regarding a second packet to be processed, second start address SA1 and second end information EI2 are derived using the aforementioned manners. Hence, a first path in the circular link list is determined based on at least the first start address SA1 and the first end information EI1, and a second path in the circular link list is determined based on at least the second start address SA2 and the second end information EI2. More specifically, the first path may be comprised of entries indexed by current addresses CA2-CA8 due to no circulation back to the entry indexed by CA0, or may be comprised of entries indexed by current addresses CA2-CA9 & CA0-CA8 due to one circulation back to the entry indexed by CA0, or may be comprised of entries indexed by a combination of more successive current addresses due to more than one circulation back to the entry indexed by CA0. The second path may be comprised of entries indexed by current addresses CA4-CA7 due to no circulation back to the entry indexed by CA0, or may be comprised of entries indexed by current addresses CA4-CA9 & CA0-CA7 due to one circulation back to the entry indexed by CA0, or may be comprised of entries indexed by a combination of more successive current addresses due to more than one circulation back to the entry indexed by CA0. As shown in FIG. 20, each of the first path and the second path has a last entry different from the last entry of the linear link list shown in FIG. 19. Besides, the first path and the second path have different first entries and different last entries. Similarly, when the proposed packet processing method is employed in a network switch, the circular link list can be re-used to meet different packet processing requirements of incoming packets of the network switch.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A packet processing method, comprising:
deriving a start address from a packet index of a packet to be processed;
deriving link-list access control information corresponding to the packet to be processed; and
reading packet information for the packet to be processed from a link list stored in a packet information table according to at least the start address and the link-list access control information, wherein the link list comprises a plurality of entries each indexed by a current address and storing at least a next address and one packet information.

2. The packet processing method of claim 1, wherein the step of deriving the link-list access control information comprises:
obtaining the link-list access control information before a first entry indexed by a current address identical to the start address is accessed.

3. The packet processing method of claim 1, wherein the step of deriving the link-list access control information comprises:
obtaining the link-list access control information when a first entry indexed by a current address identical to the start address is accessed.

4. The packet processing method of claim 3, wherein the step of obtaining the link-list access control information comprises:
reading the link-list access control information from an entry of a link-list access control information table distinct from the packet information table, wherein the entry of the link-list access control information table is indexed an address identical to the start address.

5. The packet processing method of claim 3, wherein the step of obtaining the link-list access control information comprises:
decoding packet information stored in the first entry to generate the link-list access control information.

6. The packet processing method of claim 3, wherein the step of obtaining the link-list access control information comprises:
extracting a portion of the packet information stored in the first entry as the link-list access control information.

7. The packet processing method of claim 3, wherein the step of obtaining the link-list access control information comprises:
calculating the link-list access control information based on an output of a function with an input including at least one of the current address of the first entry, packet information stored in the first entry, and a next address stored in the first entry.

8. The packet processing method of claim 1, wherein the packet information read from the link list includes packet processing information related to the packet.

9. The packet processing method of claim 8, wherein the packet processing information is replication information or packet modification information.

10. The packet processing method of claim 1, wherein the link list is a linear link list with a last entry, and a path in the linear link list that is determined by the start address and the link-list access control information has a last entry different from the last entry of the linear link list.

11. The packet processing method of claim 1, wherein the link list is a circular link list having no last entry, and a path in the circular link list that is determined by the start address and the link-list access control information has a last entry corresponding to the link-list access control information.

12. The packet processing method of claim 1, wherein the link list includes entries of a first path accessed for a first packet and entries of a second path accessed for a second packet, where the first path and the second path have different first entries or different last entries.

13. The packet processing method of claim 1, wherein the step of deriving the link-list access control information comprises:
setting the link-list access control information based on a target entry count, wherein a last entry of a path corresponding to the packet to be processed is identified in the link list when at least a number of accessed entries of the path in the link list matches the target entry count.

14. The packet processing method of claim 13, wherein the last entry of the path corresponding to the packet to be processed is identified when an output of a function with an input including at least one of the link-list access control information, packet information stored in a specific accessed entry in the link list, and a current address of the specific accessed entry, a next address stored in the specific accessed entry matches a target value after the number of accessed entries of the path in the link list matches the target entry count.

15. The packet processing method of claim 1, wherein the step of deriving the link-list access control information comprises:
setting the link-list access control information by a target current address, wherein a last entry of a path corresponding to the packet to be processed is identified in the link list when a current address of a specific accessed entry of the path in the link list matches the target current address.

16. The packet processing method of claim 1, wherein the step of deriving the link-list access control information comprises:
setting the link-list access control information by a target next address, wherein a last entry of a path corresponding to the packet to be processed is identified in the link list when a next address stored in a specific accessed entry of the path in the link list matches the target next address.

17. The packet processing method of claim 1, wherein the step of deriving the link-list access control information comprises:
setting the link-list access control information by target packet information, wherein a last entry of a path corresponding to the packet to be processed is identified in the link list when packet information stored in a specific accessed entry of the path in the link list matches the target packet information.

18. The packet processing method of claim 1, wherein a last entry of a path corresponding to the packet to be processed is identified in the link list when at least an output of a function with an input including at least one of the link-list access control information, packet information stored in a specific accessed entry in the link list, a current address of the specific accessed entry, and a next address stored in the specific accessed entry matches a target value.

19. The packet processing method of claim 18, wherein the last entry of the path corresponding to the packet to be processed is identified when a number of accessed entries in the link list matches a target entry count after the output of the function matches the target value.

20. The packet processing method of claim 1, wherein the link-list access control information is end information corresponding to the packet to be processed; and the end information indicates a last entry of the link list.

21. The packet processing method of claim 1, wherein the link-list access control information is bypass information corresponding to the packet to be processed; and the bypass information indicates whether packet information stored in an accessed entry in the link list should be retrieved.

22. The packet processing method of claim 1, wherein the link-list access control information is branch information corresponding to the packet to be processed; and the branch information indicates whether access of the link list should be branched.

23. The packet processing method of claim 22, wherein:
the branch information indicates which one of next addresses stored in an accessed entry in the link list should be used to find a next entry; or
the branch information has an address offset for an accessed entry in the link list, and a next entry in the link list is found based on a next address stored in the accessed entry and the address offset specified in the branch information for the accessed entry.

24. A packet processing apparatus, comprising:
a packet index processing circuit, arranged to derive a start address and link-list access control information from a packet index of a packet to be processed;
a storage device, arranged to store a packet information table having a link list stored therein, wherein the link list comprises a plurality of entries each indexed by a current address and storing at least a next address and one packet information; and
a table access circuit, arranged to receive the start address and the link-list access control information generated from the packet index processing circuit, and read packet information for the packet to be processed from the link list stored in the packet information table according to at least the start address and the link-list access control information.

25. A packet processing apparatus, comprising:
a packet index processing circuit, arranged to derive a start address from a packet index of a packet to be processed;
a storage device, arranged to store a packet information table having a link list stored therein, wherein the link list comprises a plurality of entries each indexed by a current address and storing at least a next address and one packet information; and
a table access circuit, arranged to read a first entry indexed by a current address identical to the start address, wherein the table access circuit derives link-list access control information when the first entry is read, and the table access circuit reads packet information for the packet to be processed from the link list stored in the packet information table according to at least the start address and the link-list access control information.
